(19) United States
(12) Patent Application Publication
(10) Pub. No.: US 2017/0101957 A1
(43) Pub. Date: Apr. 13, 2017

(54) METHOD AND APPARATUS FOR DELAY-FREE OPERATION OF A CONTROL DEVICE

(71) Applicant: Robert Bosch GmbH, Stuttgart (DE)

(72) Inventors: Axel AUE, Korntal-Muenchingen (DE); Hans-Walter SCHMITT, Weissach/Flacht (DE); Matthias SCHREIBER, Vaihngen/Enz (DE)

(21) Appl. No.: 15/291,663

(22) Filed: Oct. 12, 2016

(30) Foreign Application Priority Data
Oct. 13, 2015 (DE) 10 2015 219 844.8

(51) Int. Cl. F02D 41/26; G06F 3/06

(52) U.S. Cl. CPC F02D 41/26; G06F 3/061; G06F 3/0634; G06F 3/0679

(57) ABSTRACT

A method for operating a control device, in which in a first operating mode of the control device the first processor core is operated predominantly locally with the first flash memory, and the second processor core is operated predominantly locally with the second flash memory, in a second operating mode of the control device the first processor core and the second processor core are operated with the first flash memory, and in which in a third operating mode of the control device the first processor core and the second processor core are operated with the second flash memory.

### RELATED APPLICATION INFORMATION

The present application claims priority to and the benefit of German patent application no. 10 2015 219 844.8, which was filed in Germany on Oct. 13, 2015, the disclosure of which is incorporated herein by reference.

### FIELD OF THE INVENTION

The present invention relates to a method for delay-free operation of a control device. The present invention furthermore relates to a corresponding apparatus, to a corresponding computer program, and to a corresponding memory medium.

### BACKGROUND INFORMATION

The term “control device” refers to any electronic module (electronic control unit (ECU), electronic control module (ECM)) that is installed directly at utilization locations at which open- or closed-loop control is necessary. Control devices serve to control motor vehicles, machines, systems, and a wide variety of technical processes. In the context of present-day combustion engines, mechanical regulation concepts have been almost entirely displaced by electronic control units.

A control device corresponding to the existing art is made up of a standalone computer in the form of an embedded system. The size of this computer varies considerably depending on the complexity of its tasks, and ranges from single-chip solutions having a microcontroller with built-in RAM and ROM memory to multi-processor systems having a flash memory whose contents can be updated, for example, in a qualified technical service facility.

Patent document DE 10 2011 117376 A1 discusses a method for accepting program data via telematics into a control device of a motor vehicle. The method according to the present invention encompasses transferring new program data via mobile radio to a first memory region of a first control device, transferring the new program data to a destination control device, and automatically checking the functionality of the destination control device before the motor vehicle is enabled again.

### SUMMARY OF THE INVENTION

The invention furnishes a method for delay-free operation of a control device, a corresponding apparatus, a corresponding computer program, and a corresponding memory medium, in accordance with the descriptions herein.

An advantage of the solution advocated here is that a startup delay cannot occur, and that if necessary it is possible to work with the old (previously functional) memory image of the flash memory.

The features set forth in the further descriptions herein make possible advantageous refinements of and improvements to the basic aspects of the descriptions herein. For example, provision can be made that as a function of the operating mode of the control device, the processor cores are shifted at times into wait states in order to compensate for performance differences of the threads being executed on them. This configuration is based on the recognition that the threads of the processor core whose flash memory is available for reprogramming run more slowly, since it must execute those threads from the local flash memory of the adjacent processor core.

Exemplifying embodiments of the invention are depicted in the drawings and explained in further detail in the description below.

### BRIEF DESCRIPTION OF THE DRAWINGS

FIG. 1 schematically shows a control device in a first operating state.

FIG. 2 shows the control device in a second operating state.

FIG. 3 shows the control device in a third operating state.

### DETAILED DESCRIPTION

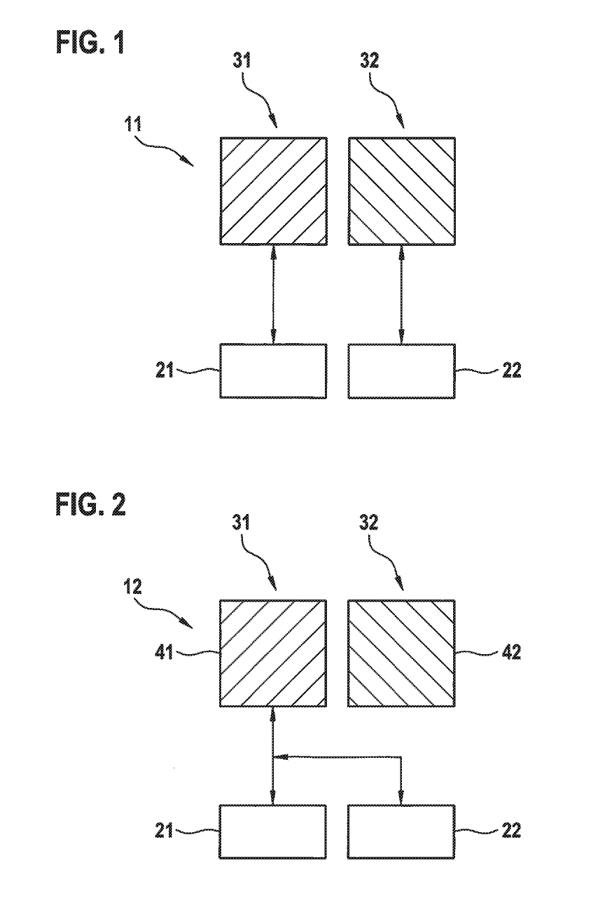

FIG. 1 shows the intended first operating mode 11 of a vehicle control device according to an embodiment of the invention. Control device 21, 22, 31, 32 is equipped in the present case with a first processor core 21, a second processor core 22, a first flash memory 31, and a second flash memory 32. First processor core 21 is operated locally with first flash memory 31, and second processor core 22 is operated locally with second flash memory 32. First flash memory 31 and second flash memory 32 are in the same program state, which corresponds to a predefined memory image.

As illustrated by FIG. 2, control device 21, 22, 31, 32 is now, with the engine running, shifted into a second operating mode 12 in order to update the second flash memory. In this second operating mode 12, both first processor core 21 and second processor core 22 are operated with first flash memory 31 and with its first memory image 41. Second flash memory 32 can thus be erased during operation of the engine, and second memory image 42 can be reprogrammed via the “over-the-air” (OTA) interface of the vehicle.

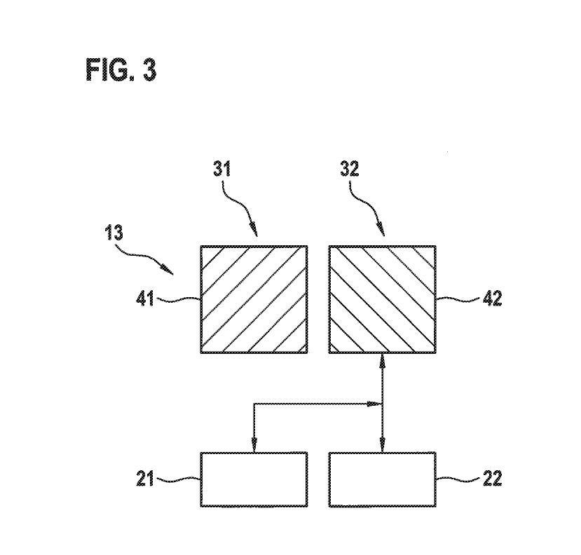

Lastly, FIG. 3 shows a third operating mode 13 of control device 21, 22, 31, 32. In this state first processor core 21 and second processor core 22 are operated with second flash memory 32. Both first processor core 21 and second processor core 22 therefore work with second memory image 42. In this third operating mode 13, first memory image 41 can therefore be reprogrammed.

This method 11, 12, 13 can be implemented in control device 21, 22, 31, 32, for example, in software or in hardware or in a mixed form made up of software and hardware.

What is claimed is:

1. A method for operating a control device having a first processor core, a second processor core, a first flash memory, and a second flash memory, the method comprising:
operating, in a first operating mode of the control device, the first processor core predominantly locally with the first flash memory, and operating the second processor core predominantly locally with the second flash memory; and
operating, in a second operating mode of the control device the first processor core and the second processor core predominantly or exclusively with the first flash memory, so that the second flash memory is reprogrammable in the meanwhile.

2. The method of claim 1, wherein in a third operating mode of the control device the first processor core and the second processor core are operated with the second flash memory.

3. The method of claim 2, wherein as a function of the operating modes, the first processor core and the second processor core are shifted at times into wait states.

4. The method of claim 1, wherein the operating mode is modified when the control device is restarted.

5. The method of claim 4, wherein after starting, an address image of the control device is selectably modified or retained.

6. The method of claim 4, wherein the control device controls an engine of a motor vehicle, and wherein the control device is started with the engine.

7. The method of claim 1, wherein updating is accomplished via an over-the-air interface.

8. A computer readable medium having a computer program, which is executable by a processor, comprising:
a program code arrangement having program code for operating a control device having a first processor core, a second processor core, a first flash memory, and a second flash memory, by performing the following:
operating, in a first operating mode of the control device, the first processor core predominantly locally with the first flash memory, and operating the second processor core predominantly locally with the second flash memory; and
operating, in a second operating mode of the control device the first processor core and the second processor core predominantly or exclusively with the first flash memory, so that the second flash memory is reprogrammable in the meanwhile.

9. The computer readable medium of claim 8, wherein in a third operating mode of the control device the first processor core and the second processor core are operated with the second flash memory.

10. An apparatus for operating a control device having a first processor core, a second processor core, a first flash memory, and a second flash memory, comprising:
an operating arrangement configured to perform the following:
operating, in a first operating mode of the control device, the first processor core predominantly locally with the first flash memory, and operating the second processor core predominantly locally with the second flash memory; and
operating, in a second operating mode of the control device the first processor core and the second processor core predominantly or exclusively with the first flash memory, so that the second flash memory is reprogrammable in the meanwhile.
